(19) United States
(12) Patent Application Publication
(10) Pub. No.: US 2020/0186294 A1
(43) Pub. Date: Jun. 11, 2020

(54) WIRELESS COMMUNICATION METHOD, WIRELESS COMMUNICATION SYSTEM, WIRELESS TERMINAL, AND BASE STATION

(71) Applicant: FUJITSU LIMITED, Kawasaki-shi (JP)

(72) Inventor: YOSHIHIRO KAWASAKI, Kawasaki (JP)

(73) Assignee: FUJITSU LIMITED, Kawasaki-shi (JP)

(21) Appl. No.: 16/786,018

(22) Filed: Feb. 10, 2020

Related U.S. Application Data
(63) Continuation of application No. PCT/JP2017/034972, filed on Sep. 27, 2017.

(51) Int. Cl. H04L 1/18

(52) U.S. Cl. CPC H04L 1/1812

(57) ABSTRACT

A wireless communication method is used in a wireless communication system including a first wireless apparatus and a second wireless apparatus. The method includes the first wireless apparatus receiving a first signal composed of a plurality of parts and a second signal including first information about the first signal from the second wireless apparatus and transmitting second information indicating a reception result of the first signal to the second wireless apparatus using a mode determined based on the first information included in the second signal, out of a plurality of modes in which the reception result is expressed differently.

### CROSS-REFERENCE TO RELATED APPLICATION

This application is a continuation application of International Application PCT/JP2017/034972 filed on Sep. 27, 2017 which designated the U.S., the entire contents of which are incorporated herein by reference.

### FIELD

The embodiments discussed herein are related to a wireless communication method, a wireless communication system, a wireless terminal, and a base station.

### BACKGROUND

On present networks, most network resources are occupied by traffic produced by mobile terminals (as examples, smartphones and feature phones). The current trend is for the traffic used by mobile terminals to continue to increase.

In response to the development of IoT (Internet of Things) services (as examples, monitoring systems for traffic systems, smart meters, equipment, and the like), there is also demand for networks to handle services with various requirements. For this reason, next-generation communication standards (for example, “5G” (5th Generation mobile communication)) seeks technology that achieves ever higher data rates, higher capacity, and lower latency in addition to 4G (4th Generation mobile communication) standard technology.

The 5G communication standard is currently under consideration, and in addition to a conventional method where a reception result (which is “ACK” (Acknowledgement) or “NACK” (Negative-ACK)) is sent back in TB (Transport Block) units, discussions are underway into newly introducing a CBG (Code Block Group)-based wireless data transmission method (hereinafter referred to as the “CBG method”) where reception results are sent back in units of code block groups produced by dividing transport blocks.

With the conventional method, when reception fails, an entire transport block is retransmitted. With the CBG method however, only code block groups for which reception failed are retransmitted. This makes it possible to save on the wireless resources used during retransmission, which may improve the usage efficiency of wireless resources.

As described above, with the CBG method, an ACK or NACK is sent back for each of a plurality of code block groups that compose a transport block, and only code block groups corresponding to a NACK are retransmitted. When ACK is sent back for all the retransmitted code block groups, transmission is complete.

See, for example, “3GPP TR 38.802 V14.0.0 (2017-03)”.

In the conventional method described above, one ACK or NACK is sent back in one response to one transport block. On the other hand, with the CBG method, as a maximum, a number of ACKs or NACKs that is equal to the number of code block groups composing a transport block are sent back in one response to one transport block. This means that when there is a restriction on the amount of power that may be used in one response, there are cases with the CBG method where the amount of power that may be used for the transmission of one ACK or NACK falls. When the amount of power that may be used falls, transmission becomes more susceptible to the influence of noise and the like, which makes erroneous determination of ACK/NACK more likely to occur.

Although the CBG method has been described here as an example for ease of explanation, the same problem may also occur in other cases where the unit of retransmission control is set at any block that is smaller than a transport block.

### SUMMARY

According to one aspect, there is provided a wireless communication method used in a wireless communication system including a first wireless apparatus and a second wireless apparatus, the wireless communication method including: receiving, by the first wireless apparatus, a first signal composed of a plurality of parts and a second signal including first information about the first signal from the second wireless apparatus; and transmitting, by the first wireless apparatus, second information indicating a reception result of the first signal to the second wireless apparatus using a mode determined based on the first information included in the second signal, out of a plurality of modes in which the reception result is expressed differently.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts one example of a wireless communication system according to a first embodiment;

FIG. 2 depicts an example of a wireless communication system according to a second embodiment;

FIG. 3 is a block diagram depicting example hardware that is capable of realizing the functions of a base station according to the second embodiment;

FIG. 4 is a block diagram depicting example hardware capable of realizing the functions of a wireless terminal according to the second embodiment;

FIG. 5 is a block diagram depicting example functions of the base station according to the second embodiment;

FIG. 6 is a diagram depicting an example of format determination information according to the second embodiment;

FIG. 7 is a block diagram depicting example functions of the wireless terminal according to the second embodiment;

FIG. 8 is a diagram useful in explaining the difference between a TB-based wireless data transmission method (TB method) and a CBG-based wireless data transmission method (CBG method);

FIG. 9 is a diagram useful in explaining a fall in usage efficiency of wireless resources that results from erroneous determination of ACK/NACK;

FIG. 10 is a diagram useful in explaining an arrangement for retransmission control according to the second embodiment.

FIG. 11 is a first flowchart depicting the operation of the wireless terminal according to the second embodiment;

FIG. 12 is a second flowchart depicting the operation of the wireless terminal according to the second embodiment;

FIG. 13 is a flowchart depicting the operation of the base station according to the second embodiment; and

FIG. 14 is a diagram useful in explaining a modification to the second embodiment.

### DESCRIPTION OF EMBODIMENTS

Several embodiments will be described below with reference to the accompanying drawings. Note that in the present specification and the drawings, elements with effectively the same functions have been assigned the same reference numerals and description thereof may be omitted.

### 1. First Embodiment

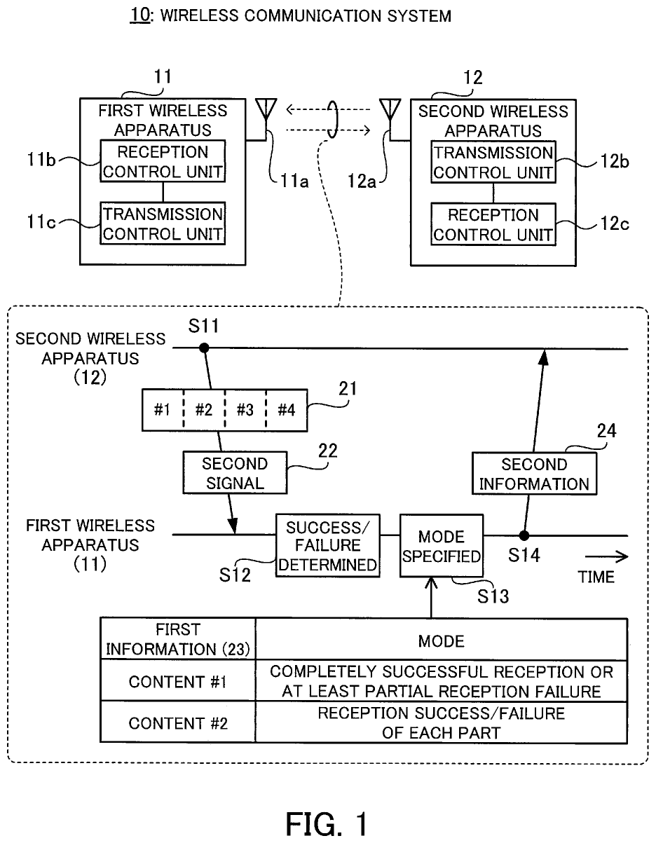

A first embodiment will now be described with reference to FIG. 1.

FIG. 1 depicts one example of a wireless communication system according to the first embodiment. Note that the wireless communication system 10 depicted in FIG. 1 is one example of a wireless communication system according to the first embodiment.

As depicted in FIG. 1, the wireless communication system 10 includes a first wireless apparatus 11 and a second wireless apparatus 12 that is capable of wireless communication with the first wireless apparatus 11.

As examples, the first wireless apparatus 11 may be a mobile terminal, such as a smartphone or a feature phone, a wireless terminal such as an MTC (Machine Type Communication) terminal for communication between small modules without human intervention, or a relay station that relays communications between a base station and a wireless terminal. Note that the wireless communication system 10 may include two or more wireless devices with the same functions as the first wireless apparatus 11.

The first wireless apparatus 11 includes an antenna 11a, a reception control unit 11b, and a transmission control unit 11c. The second wireless apparatus 12 includes an antenna 12a, a transmission control unit 12b, and a reception control unit 12c. Note that the number of antennas mounted on the first wireless apparatus 11 and the second wireless apparatus 12 may be two or more.

As examples, the transmission control units 11c and 12b and the reception control units 11b and 12c are each a processor such as a CPU (Central Processing Unit), a DSP (Digital Signal Processor), an ASIC (Application Specific Integrated Circuit), or an FPGA (Field Programmable Gate Array). The transmission control units 11c and 12b and the reception control units 11b and 12c may use a storage device (not illustrated) such as RAM (Random Access Memory), an HDD (Hard Disk Drive), or flash memory as buffer memory.

The transmission control unit 12b of the second wireless apparatus 12 transmits a first signal 21 composed of a plurality of parts to the first wireless apparatus 11. In the example in FIG. 1, the first signal 21 is composed of four parts #1, #2, #3, and #4. Note that a transport block (hereinafter “TB”) is an example of the first signal 21. A code block group (hereinafter “CBG”) is an example of a part that composes the first signal 21.

The transmission control unit 12b of the second wireless apparatus 12 transmits a second signal 22 including first information 23 about the first signal 21 to the first wireless apparatus 11. The first information 23 is information about processing applied to the first signal 21 by the second wireless apparatus 12.

As one example, the first information 23 is a numerical value determined by a combination of a modulation scheme and a coding rate used on the first signal 21. Note that an MCS (Modulation and Coding Scheme) index is one example of a numerical value determined by a combination of a modulation scheme and a coding rate. The MCS index indicates an MCS to be used for transmission and reception on a PDSCH (Physical Downlink Shared CHannel), and its notification is given on a PDCCH (Physical Downlink Control CHannel), for example.

The reception control unit 11b of the first wireless apparatus 11 receives the first signal 21 and the second signal from the second wireless apparatus 12. In addition, the transmission control unit 11c of the first wireless apparatus 11 transmits second information 24 to the second wireless apparatus 12. The second information 24 indicates the reception result for the first signal 21 using a mode determined based on the first information 23 included in the second signal 22, out of a plurality of modes in which reception results are expressed differently.

Note that as examples, the plurality of modes may include a mode (“mode X”) where the reception success/failure of the entire first signal 21 is expressed as the reception result and a mode (“mode Y”) where reception success/failure of each part of the first signal 21 is separately expressed as the reception result.

As one example, when the transmission path environment is relatively good, the mode determined as described above is mode Y, while when the transmission path environment is relatively poor, mode X is determined. Note that the quality of the transmission path environment may be determined for example from the content of the processing applied to the transmission of the first signal 21. As one example, when the processing results in a relatively high transmission rate (that is, the number of information bits per symbol), it is preferable to choose mode Y, while when the processing results in a relatively low transmission rate, it is preferable to choose mode X.

In mode X, it is sufficient to send a response signal including a single indication of reception success or failure (ACK or NACK) for the first signal 21. This means that when there is a restriction on the amount of power that is used to transmit a response signal, the maximum amount of power may be allocated to the transmission of one ACK or NACK, which reduces the risk of erroneous determination of ACK/NACK at the receiver side.

On the other hand, in mode Y, a response signal including an indication of ACK or NACK for each part of the first signal 21 is sent. For this reason, the maximum amount of power is allocated to a number of ACK or NACK that is equal to the number of transmitted parts, resulting in the amount of power available to transmit one ACK or NACK being reduced. On the other hand, since it is possible to perform control so that only parts where an error has occurred are retransmitted, it becomes possible to save on the wireless resources used for retransmission, which contributes to an improvement in the usage efficiency of wireless resources.

By determining the mode to be applied to transmission of the second information 24 based on the first information 23, it is possible to achieve a favorable balance between reducing the risk of erroneous determination of ACK/NACK and improving the usage efficiency of wireless resources.

The flow of the processing described above will now be described in more detail with reference to a specific example.

In the example in FIG. 1, the transmission control unit 12b of the second wireless apparatus 12 transmits the first signal 21, which is composed of four parts #1, #2, #3, and #4, to the first wireless apparatus 11 (S11). The transmission control unit 12b also transmits the second signal 22, which includes the first information 23 indicating the content of the processing applied when the first signal 21 is transmitted.

The reception control unit 11b of the first wireless apparatus 11 receives the first signal 21 and the second signal 22. The reception control unit 11b then determines whether reception succeeded or failed for each part included in the first signal 21 (S12). As one example, the reception control unit 11b performs error detection on each part using a CRC (Cyclic Redundancy Check) assigned to each part, determines that parts with no errors have been successfully received, and determines reception has failed for parts where an error has been detected.

The transmission control unit 12b of the first wireless apparatus 11 specifies, based on the first information 23 included in the second signal 22, the method of expressing the second information 24 (i.e., the “mode”) which is to indicate the reception result of the first signal 21 (S13).

In the example in FIG. 1, when the content of the first information 23 is content #1, a mode (mode X) is specified that expresses either that reception succeeded for the entire first signal 21 (completely successful reception) or that reception of at least part of the first signal 21 failed (at least partial reception failure) as the reception result. As one example, content #1 is where the MCS index is a predetermined value or lower.

On the other hand, when the content of the first information 23 is content #2, a mode (mode Y) is specified that expresses whether reception succeeded or failed for each part of the first signal 21 (reception success/failure of each part) as the reception result. As one example, content #2 is where the MCS index exceeds the predetermined value.

Based on the determination result of S12, the transmission control unit 11c of the first wireless apparatus 11 generates the second information 24 indicating the reception result that is expressed according to the specified mode, and transmits the second information 24 to the second wireless apparatus 12 (S14).

As one example, when mode X has been specified and errors have been detected for parts #1 and #3, the transmission control unit 11c transmits the second information 24 (one NACK) indicating at least partial reception failure to the second wireless apparatus 12. When mode X has been specified and there was no error for any of parts #1, #2, #3, and #4, the transmission control unit 11c transmits the second information 24 (one ACK) indicating completely successful reception as the second information 24 to the second wireless apparatus 12.

When mode Y has been specified and errors have been detected for parts #1 and #3, the transmission control unit 11c transmits the second information 24 indicating reception failure of parts #1 and #3 (that is, two NACKs corresponding to parts #1 and #3 and two ACKs corresponding to parts #2 and #4) to the second wireless apparatus 12. When the mode Y has been specified and there was no error for any of parts #1, #2, #3, and #4, the transmission control unit 11c sends the second information 24 (that is, four ACKs) to the second wireless apparatus 12.

As described above, by changing the method of expressing the reception result based on information about the first signal 21 (that is, the “first information 23”), it is possible to control the amount of power allocated to each ACK/NACK in one response in accordance with the wireless environment and therefore possible to reduce the risk of erroneous determination of ACK/NACK. As a result, this contributes to a reduction in wasteful processing and a reduction in wasteful use of resources due to erroneous determination of ACK/NACK.

This completes the explanation of the first embodiment.

### 2. Second Embodiment

Next, a second embodiment will be described.

System

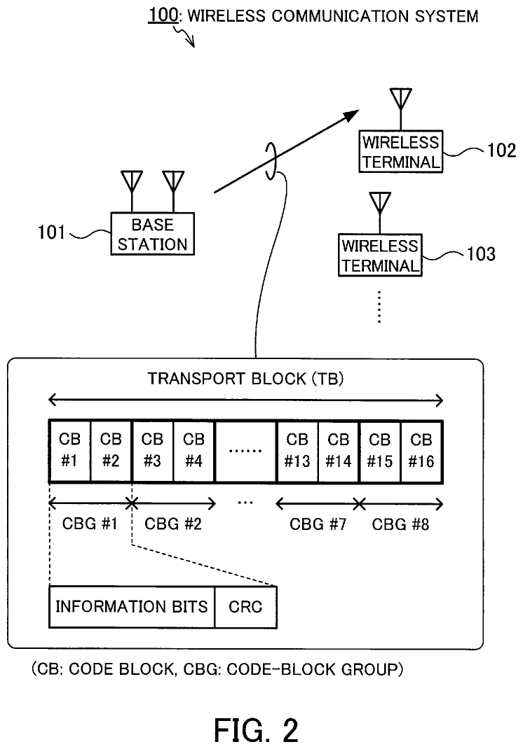

A wireless communication system 100 will now be described with reference to FIG. 2. FIG. 2 depicts an example of a wireless communication system according to the second embodiment. Here, the wireless communication system 100 is an example of a wireless communication system according to the second embodiment.

As depicted in FIG. 2, the wireless communication system 100 includes a base station 101 and wireless terminals 102 and 103 that communicate with the base station 101.

Note that the number of wireless terminals included in the wireless communication system 100 may be a number aside from two. For ease of explanation, it is assumed here that the hardware and functions of the wireless terminals 102 and 103 are effectively the same, and therefore description of the wireless terminal 103 is omitted below. Here, gNB (gNodeB) is an example of the base station 101. UE (User Equipment) is an example of the wireless terminals 102 and 103.

The wireless communication system 100 applies the CBG method to the transmission of TB.

With the CBG method, as depicted in FIG. 2, one TB is divided into a plurality of CBs (Code Blocks), and CBGs that include at least one CB are set. Note that a TB is a data chunk that is exchanged between independent layers (between the MAC layer and the PHY layer), and a CBG is a data chunk exchanged within one layer (the PHY layer).

In the example in FIG. 2, two CBs are included in one CBG. With the CBG method, ACK/NACK signals indicating a reception result (ACK/NACK) are transmitted in CBG units. This means that with the CBG method, retransmission control may be performed in CBG units. Hereinafter, for ease of explanation, a signal indicating ACK or NACK for one block or data range is referred to as an “ACK/NACK signal”, and a group of ACK/NACK signals send back in one response is referred to as a “response signal”.

A CRC (not illustrated) used for error detection for the entire TB is assigned to a TB. In the CBG method, a CRC used for error detection of individual CBGs is added to the information bits of the CBGs. Error detection is then performed using the CRC assigned to each CBG, and ACK/NACK signals indicating reception results in CBG units are transmitted based on the error detection results.

When the TB method is used and an error is detected for part of a TB, the entire TB is retransmitted. On the other hand, when the CBG method is used and an error is detected for some CBGs, the CBGs for which errors were detected are retransmitted. In other words, retransmission of CBGs that have been properly received is avoided. This means that compared to the TB method, the CBG method may suppress the use of wireless resources for retransmission, and thereby contribute to an improvement in the usage efficiency of wireless resources.

Note that although FIG. 2 depicts an example where one TB is divided into sixteen CBs and two CBs are included in each CBG, the number of CBGs that compose one TB is not limited to this example. In the following description, for ease of explanation, a case where the number of CBGs included in one TB is set at four will be described as an example.

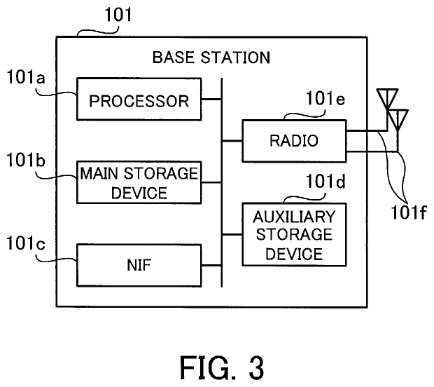

The base station 101 includes hardware like that depicted in FIG. 3, for example.

FIG. 3 is a block diagram depicting example hardware that is capable of realizing the functions of a base station according to the second embodiment. As depicted in FIG. 3, the base station 101 includes a processor 101a, a main storage device 101b, a network interface (NIF) 101c, an auxiliary storage device 101d, a radio 101e, and an antenna 101f.

As examples, the processor 101a may be a CPU, a DSP, an ASIC, or an FPGA. The processor 101a controls the operations of the base station 101 using a program and/or data stored in the main storage device 101b and/or the auxiliary storage device 101d. As one example, the main storage device 101b is a memory such as RAM. The NIF 101c is a communication circuit that acts as an interface for a core network (not illustrated) connected to an upper layer.

The auxiliary storage device 101d is a storage device such as a RAM, a ROM (Read Only Memory), an HDD, an SSD (Solid State Drive), or a flash memory. The radio 101e is a transmission and reception device that performs modulation/demodulation, frequency conversion, AD (Analog to Digital)/DA (Digital to Analog) conversion, and the like.

The antenna 101f is an antenna used for transmission/reception of RF (Radio Frequency) signals. Note that the number of antennas mounted on the base station 101 may be a number aside from two, and as one example, the antenna 101f may be an array antenna formed by a large number of antenna elements. Also, as a modification, a transmission and reception unit (for example, an RRH (Remote Radio Head) with the functions of the radio 101e and the antenna 101f may be installed so as to have a line connection to the base station 101.

Note that the functions of the second wireless apparatus 12 according to the first embodiment described above may also be realized by the hardware depicted in FIG. 3.

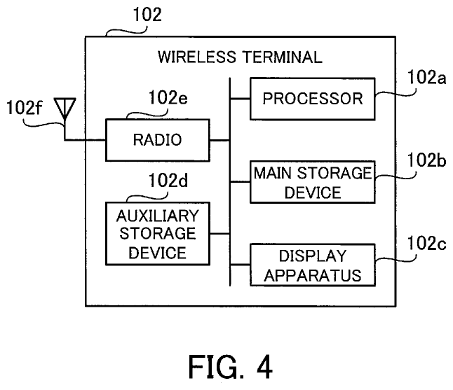

As one example, the wireless terminal 102 includes hardware like that depicted in FIG. 4.

FIG. 4 is a block diagram depicting example hardware capable of realizing the functions of the wireless terminal according to the second embodiment. As depicted in FIG. 4, the wireless terminal 102 includes a processor 102a, a main storage device 102b, a display apparatus 102c, an auxiliary storage device 102d, a radio 102e, and an antenna 102f.

As examples, the processor 102a may be a CPU, a DSP, an ASIC, or an FPGA. The processor 102a controls the operations of the wireless terminal 102 using a program and/or data stored in the main storage device 102b and/or the auxiliary storage device 102d. As one example, the main storage device 102b is a memory such as a RAM. As examples, the display apparatus 102c is an LCD (Liquid Crystal Display), or an ELD (Electro-Luminescent Display).

As examples, the auxiliary storage device 102d is a storage device such as a RAM, a ROM, an HDD, an SSD, or a flash memory. The radio 102e is a transmission and reception device that performs modulation/demodulation, frequency conversion, AD/DA conversion, and the like. The antenna 102f is an antenna used for transmission and reception of RF signals. Note that the number of antennas mounted on the wireless terminal 102 may be two or more.

Note that the functions of the first wireless apparatus 11 according to the first embodiment described above may also be realized by the hardware depicted in FIG. 4.

Functions

Next, the functions of the base station 101 and the wireless terminal 102 will be described. Note that it is assumed that the functions of the wireless terminals 102 and 103 are the same and therefore description of the wireless terminal 103 is omitted.

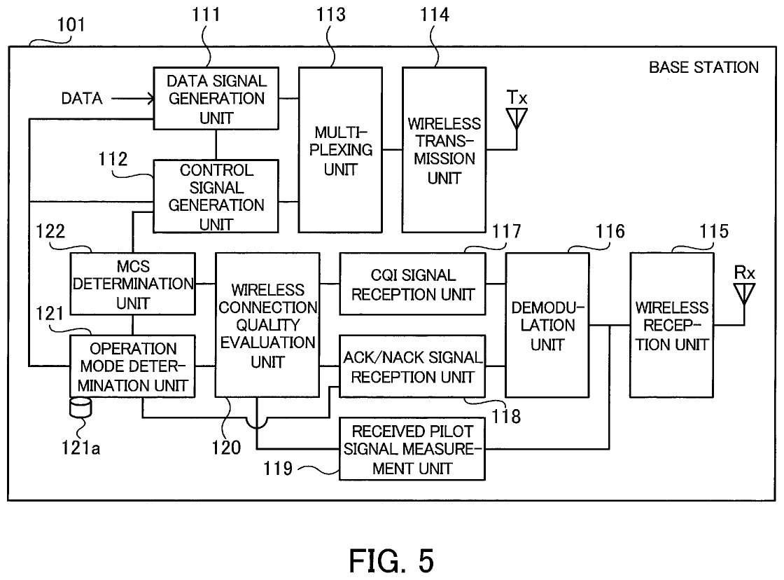

The base station 101 has the functions depicted in FIG. 5. FIG. 5 is a block diagram depicting example functions of the base station according to the second embodiment.

As depicted in FIG. 5, the base station 101 includes a data signal generation unit 111, a control signal generation unit 112, a multiplexing unit 113, and a wireless transmission unit 114. The base station 101 also includes a wireless reception unit 115, a demodulation unit 116, a CQI (Channel Quality Indicator) signal reception unit 117, an ACK/NACK signal reception unit 118, a received pilot signal measurement unit 119, a wireless connection quality evaluation unit 120, an operation mode determination unit 121, and an MCS determination unit 122.

Note that although a transmission antenna Tx and a reception antenna Rx are described here as separate antennas for ease of explanation, the functions of the transmission antenna Tx and the reception antenna Rx may be realized by the same antenna. In addition, a plurality of antennas may be used as the transmission antenna Tx, and/or a plurality of antennas may be used as the reception antenna Rx.

The functions of the data signal generation unit 111, the control signal generation unit 112, the CQI signal reception unit 117, the ACK/NACK signal reception unit 118, the received pilot signal measurement unit 119, the wireless connection quality evaluation unit 120, the operation mode determination unit 121, and the MCS determination unit 122 may be realized by the processor 101a described above. The functions of the multiplexing unit 113, the wireless transmission unit 114, the wireless reception unit 115, and the demodulation unit 116 may be realized by the radio 101e described above.

The data signal generation unit 111 generates a data signal (TB) from the generated data.

For example, the data signal generation unit 111 divides the data to generate CB, groups a predetermined number of (for example, two) CBs to form CBGs, and calculates a CRC for each CBG. The data signal generation unit 111 also calculates the CRC of the data as a whole, and generates a signal including the data itself, the CRCs in CBG units, and the CRC of the entire data as a data signal. Note that the data is encoded (for example, turbo-encoded) according to a predetermined encoding method.

When retransmission is performed, the data signal generation unit 111 specifies CBGs to be retransmitted (or “retransmission target CBGs”) based on the result of ACK/NACK determination by the ACK/NACK signal reception unit 118 described later, and generates a data signal including the specified retransmission target CBGs. The method for specifying the retransmission target CBGs will be described later.

The control signal generation unit 112 generates an L1 control signal (hereinafter simply referred to as the “control signal”) including a bitmap-type flag (BM) that indicates which CBGs are included in the data signal and a retransmission determination flag (NR) that indicates whether the transmission of the data signal is transmission of new data or a retransmission. As one example, the BM may be expressed by a bit string in which CBGs included in the data signal are expressed by the bit value “1” and CBGs not included in the data signal are expressed by the bit value “0”.

The data signal and the control signal are multiplexed (as one example, time multiplexed) by the multiplexing unit 113 and are transmitted by the wireless transmission unit 114 via the antenna Tx. Note that the MCS applied to the transmission of the data signal is determined by the MCS determination unit 122, described later. Notification of an MCS index indicating the MCS applied to the transmission is given in advance to the wireless terminal 102 via the PDCCH as a part of the DCI (Downlink Control Information), for example.

Example methods of determining the MCS include a method that uses an evaluation result of wireless connection quality based on a reception result of a pilot signal transmitted on the PUSCH and a method that makes the determination based on CQI fed back from the wireless terminal 102.

When TDD (Time Division Duplex) is used, the reception result of the pilot signal may be used to determine the MCS to be applied when transmitting UL (Uplink) data. In this case, the pilot signal received by the wireless reception unit 115 is outputted to the received pilot signal measurement unit 119, where measurement of the received power, the SINR (Signal to Interference Noise Ratio), and the like is performed.

When CQI is used, a CQI signal received by the wireless reception unit 115 is outputted to the CQI signal reception unit 117, where, as one example, quality information (the modulation method, coding rate, transfer rate, and the like) indicated by the CQI signal is specified.

The CQI signal is determined based on the reception result of a pilot signal transmitted on a downlink (DL), and as one example is transmitted at predetermined timing (for example, at intervals of several tens of ms) via the PUCCH (Physical Uplink Control CHannel). Note that the CQI signal may be transmitted on the PUSCH (Physical Uplink Shared CHannel).

The wireless connection quality evaluation unit 120 evaluates the wireless connection quality based on the quality information described above and the measurement result produced by the received pilot signal measurement unit 119. The evaluation result produced by the wireless connection quality evaluation unit 120 is outputted to the MCS determination unit 122. The MCS determination unit 122 determines the MCS index based on the evaluation result produced by the wireless connection quality evaluation unit 120.

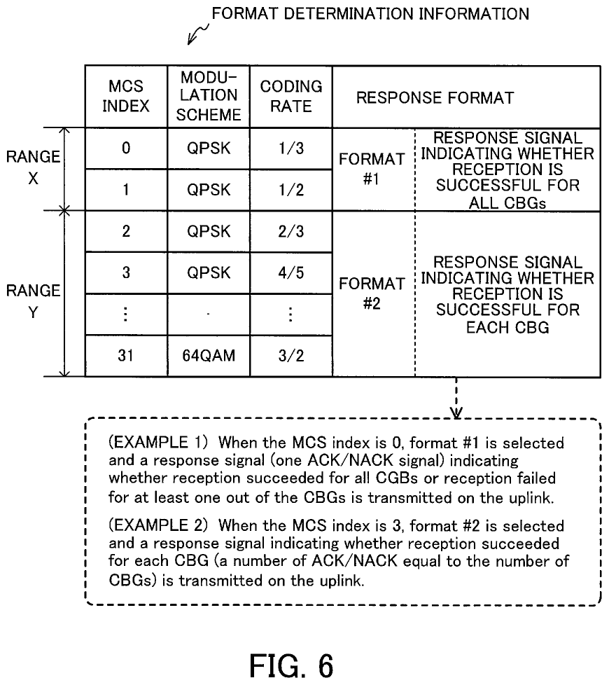

The operation mode determination unit 121 determines a response format corresponding to the MCS index determined by the MCS determination unit 122 based on format determination information (see FIG. 6) held in the storage unit 121a. The operation mode determination unit 121 then sets an operation mode in accordance with the response format. Note that the expression “response format” here refers to a method of expressing a response signal indicating the reception result of the data signal. The functions of the storage unit 121a may be realized by the main storage device 101b and/or the auxiliary storage device 101d described above. The format determination information and a method of determining the response format will be described later.

The format determination information will now be described with reference to FIG. 6. FIG. 6 is a diagram depicting an example of format determination information according to the second embodiment. Note that the content of the information illustrated in FIG. 6 is merely one example and may be changed as appropriate according to the specific implementation.

In the example in FIG. 6, the format determination information includes information about the MCS index, the modulation scheme, the coding rate, and the response format. Note that although information about the modulation scheme and coding rate is illustrated in this example for ease of explanation, when the modulation scheme and coding rate are uniquely specified from the MCS index, this information may be omitted.

The format determination information associates the MCS index with a type of response format. In the wireless communication system 100, the content of the response signal that gives notification of the reception result changes according to the selected response format, even when the reception result is the same. In FIG. 6, formats #1 and #2 are depicted as examples of response formats.

Format #1 is a format in which a response signal indicates whether reception was successful for every transmitted CBG. When format #1 is used and reception of every transmitted CBG was successful, one ACK/NACK signal indicating ACK is sent back as the response signal, while when reception of at least one CBG failed, one ACK/NACK signal indicating NACK is sent back as the response signal.

When format #1 is used, the base station 101 is capable of recognizing, based on the response signal, whether reception succeeded or failed for the entire group of transmitted CBGs. In addition, since one ACK/NACK signal is transmitted as the response signal, the response signal may be transmitted using the maximum amount of power that may be used in one response (as one example, the same amount of power as with the TB method). As a result, when format #1 is used, compared to a case where a response signal including the same number of ACK/NACK signals as the number of CBGs is transmitted, resistance to noise and the like is increased and the risk of erroneous determination of ACK/NACK for the response signal is reduced.

On the other hand, format #2 is a format in which a response signal indicates whether reception was successful for each CBG. When format #2 is used, a response signal indicating ACK/NACK in CBG units is sent back. In this case, it is possible to perform control that retransmits only CBGs corresponding to a NACK (that is, control according to the CBG method), which contributes to improving the usage efficiency of wireless resources.

However, compared to when format #1 is used, when format #2 is used, there is a higher risk of erroneous determination of ACK/NACK for each CBG. For this reason, as depicted in FIG. 6, an arrangement that controls the response format according to the MCS index is introduced in the second embodiment.

In the format determination information illustrated in FIG. 6, format #1 is associated with a range X where the MCS index is 1 or below, and format #2 is associated with a range Y where the MCS index is 2 or higher (that is, a range Y where the MCS index is larger than the range X).

As the modulation scheme, there is a tendency to use a multilevel modulation scheme (that is, a modulation scheme with a large number of bits that may be transmitted in one symbol) as the MCS index increases. As one example, the modulation scheme used when the MCS index is 0 is QPSK (Quadrature Phase Shift Keying), while the modulation scheme used when the MCS index is 31 is 64 QAM (Quadrature Amplitude Modulation).

On the other hand, regarding the coding rate, for a set of MCS indices with the same modulation scheme, the coding rate increases as the MCS index increases. The coding rate is a ratio of the number of code bits to the number of input bits representing information to be transmitted. As one example, when the coding rate is ⅓, three code bits are allocated to one input bit. That is, the smaller the coding rate, the higher the redundancy and the higher the error correction capability, though this causes a drop in transmission efficiency.

In a normal setting, a relatively large MCS index is selected when the transmission path characteristics are favorable, and a relatively small MCS index is selected when the transmission path characteristics are not favorable and/or when a signal for which reliability is prioritized is to be transmitted.

The selection of the MCS index is performed by the base station 101 based on the wireless connection quality measured using a pilot signal or the like transmitted on the uplink, for example, or is performed by the base station 101 based on the CQI or the like fed back to the base station 101. However, it is possible to select the MCS index at the terminal side, such as the wireless terminal 102 (as a modification).

As described above, when a relatively small MCS index (for example, an MCS index within the range X) has been selected, in many cases the wireless connection quality is not favorable. For this reason, in a situation where an MCS index within the range X is selected, there will be a high risk of erroneous determination of ACK/NACK occurring when a response signal is returned according to format #2.

For the reason given above, in the second embodiment, format #1 is associated with MCS indices in the range X as depicted in FIG. 6, and format #1 is used when an MCS index in the range X is selected, thereby suppressing erroneous determination of ACK/NACK. On the other hand, format #2 is associated with MCS indices in range Y, and when an MCS index in range Y is selected, format #2 is used to improve the usage efficiency of wireless resources.

Note that the boundary of the ranges into which formats #1 and #2 are divided may be set in advance. Although formats #1 and #2 are divided at the boundary between the MCS indices 1 and in the example in FIG. 6, it is possible to appropriately change the position where the boundary is set according to the specific implementation. The boundary may also be controlled by signaling with an upper layer.

Also, although two response formats are illustrated in the example in FIG. 6, other formats such as format #3 in which a response signal indicates reception success or failure for a CBG set including two or more CBGs may be added. It is also possible to use a modification that uses three formats including other formats or a modification where either of format #1 or #2 is replaced with another format. It is obvious that these modifications belong to the technical scope of the second embodiment.

The description will now return to FIG. 5. Notification of the response format determined by the operation mode determination unit 121 is given to the data signal generation unit 111, the control signal generation unit 112, and the ACK/NACK signal reception unit 118. The data signal generation unit 111 and the control signal generation unit 112 specify the retransmission target CBGs according to the reception result of the response signal determined by the ACK/NACK signal reception unit 118 with consideration to the response format described above. On the other hand, the ACK/NACK signal reception unit 118 performs reception control of a response signal transmitted from the wireless terminal 102 according to the response format described above.

For example, when format #1 is used, a response signal including one ACK/NACK signal, which indicates reception success or failure for the entire set of CBG that have been transmitted, is outputted via the wireless reception unit 115 and the demodulation unit 116 to the ACK/NACK signal reception unit 118. On the other hand, when format #2 is used, a response signal including a number of ACK/NACK signals equal to the number of transmitted CBGs is outputted via the wireless reception unit 115 and the demodulation unit 116 to the ACK/NACK signal reception unit 118. The ACK/NACK signal reception unit 118 makes a determination of ACK/NACK for each ACK/NACK signal in the response signal.

The data signal generation unit 111 generates a data signal including retransmission target CBG based on the result of ACK/NACK determination by the ACK/NACK signal reception unit 118. When format #1 is used and the ACK/NACK signal reception unit 118 has determined a NACK, the data signal generation unit 111 generates a data signal including all of the CBGs (retransmission target CBGs) that were transmitted in the previous transmission. When format #2 is used, the data signal generation unit 111 generates a data signal including the CBGs (retransmission target CBGs) that correspond to a NACK.

The control signal generation unit 112 generates a BM indicating the retransmission target CBGs and an NR indicating retransmission in accordance with the response format, and generates a control signal including the generated BM and NR. The data signal and the control signal are multiplexed by the multiplexing unit 113 and transmitted by the wireless transmission unit 114.

As described above, the base station 101 selects the response format according to the determined MCS index, and performs reception control of the response signal, specifying of the retransmission target CBGs, and the like.

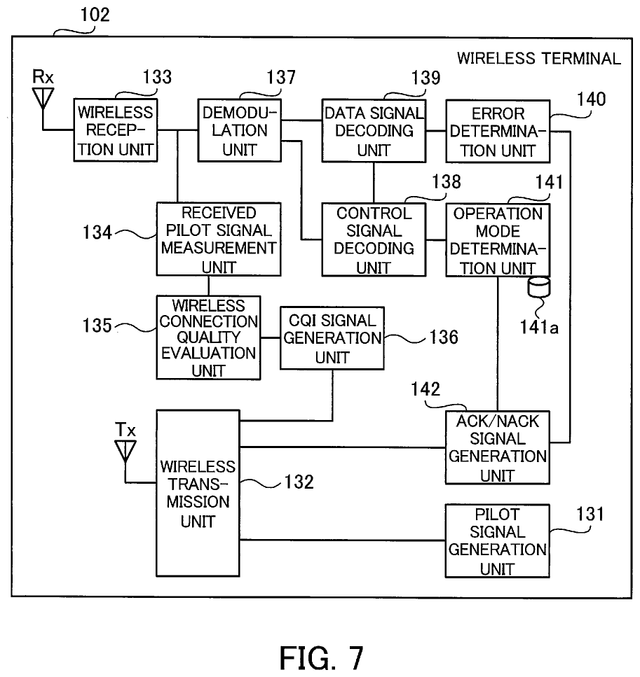

The wireless terminal 102 has functions like those depicted in FIG. 7. FIG. 7 is a block diagram depicting example functions of the wireless terminal according to the second embodiment.

As depicted in FIG. 7, the wireless terminal 102 includes a pilot signal generation unit 131, a wireless transmission unit 132, a wireless reception unit 133, a received pilot signal measurement unit 134, a wireless connection quality evaluation unit 135, and a CQI signal generation unit 136. The wireless terminal 102 also includes a demodulation unit 137, a control signal decoding unit 138, a data signal decoding unit 139, an error determination unit 140, an operation mode determination unit 141, and an ACK/NACK signal generation unit 142.

Note that although the transmission antenna Tx and the reception antenna Rx are described here as separate antennas for ease of explanation, the functions of the transmission antenna Tx and the reception antenna Rx may be realized by the same antenna. In addition, a plurality of antennas may be used as the transmission antenna Tx, and/or a plurality of antennas may be used as the reception antenna Rx.

The functions of the pilot signal generation unit 131, the received pilot signal measurement unit 134, the wireless connection quality evaluation unit 135, the CQI signal generation unit 136, the control signal decoding unit 138, the data signal decoding unit 139, the error determination unit 140, the operation mode determination unit 141, and the ACK/NACK signal generation unit 142 may be realized by the processor 102a mentioned above. The functions of the wireless transmission unit 132, the wireless reception unit 133, and the demodulation unit 137 may be realized by the radio 102e mentioned above.

The pilot signal generation unit 131 generates a pilot signal that is to be transmitted in order to measure the quality of a wireless connection. The pilot signal generated by the pilot signal generation unit 131 is transmitted by the wireless transmission unit 132 via the transmission antenna Tx. On the other hand, the wireless reception unit 133 receives a pilot signal transmitted from the base station 101 and outputs the received pilot signal to the received pilot signal measurement unit 134. The received pilot signal measurement unit 134 measures the reception power, SINR, and the like of the received pilot signal.

The wireless connection quality evaluation unit 135 evaluates the wireless connection quality based on the measurement result produced by the received pilot signal measurement unit 134 and determines the CQI based on the evaluation result. The CQI signal generation unit 136 generates a CQI signal indicating the CQI determined by the wireless connection quality evaluation unit 135. The CQI signal generated by the CQI signal generation unit 136 is transmitted to the base station 101 by the wireless transmission unit 132. Note that the reception of the pilot signal, the transmission of the CQI signal, and the like described above may be performed at predetermined timing (such as intervals of several tens of ms), for example.

The data signal received by the wireless reception unit 133 via the reception antenna Rx is demodulated by the demodulation unit 137 and then inputted into the data signal decoding unit 139. The control signal received by the wireless reception unit 133 together with the data signal is demodulated by the demodulation unit 137 and then inputted into the control signal decoding unit 138. The error determination unit 140 performs error detection for each CBG included in the data signal after decoding by the data signal decoding unit 139 to determine whether there is an error for each CBG.

The operation mode determination unit 141 determines the response format from the MCS index indicating the MCS applied to the transmission of the data signal, based on the format determination information (see FIG. 6) stored in the storage unit 141a. The operation mode determination unit 141 then sets an operation mode according to the response format. The ACK/NACK signal generation unit 142 generates a response signal which is based on the determination result produced by the error determination unit 140 and complies with the determination result (format #1 or #2) produced by the operation mode determination unit 141.

When format #1 is used and it is determined that there are no errors in any of the transmitted CBGs, the ACK/NACK signal generation unit 142 generates a response signal indicating ACK. On the other hand, when it is determined that there is an error in at least one CBG out of the transmitted CBGs, the ACK/NACK signal generation unit 142 generates a response signal indicating NACK. That is, when format #1 is used, the ACK/NACK signal generation unit 142 generates one ACK/NACK signal indicating ACK or NACK as the response signal.

When format #2 is used, the ACK/NACK signal generation unit 142 generates an ACK/NACK signal indicating a determination result for each transmitted CBG and generates a response signal including an equal number of ACK/NACK signals to the number of CBGs. The response signal generated by the ACK/NACK signal generation unit 142 is transmitted to the base station 101 by the wireless transmission unit 132.

As described above, the wireless terminal 102 determines the response format according to the determined MCS index, and controls the method of expression used for the response signal according to the response format. The amount of power allocated to one ACK/NACK signal is larger when format #1 is used, than when format #2 where a number of ACK/NACK signals equal to the number of CBGs are transmitted is used, which makes it less likely for erroneous determination of ACK/NACK to occur at the base station 101. On the other hand, when format #2 is used, since the number of retransmission target CBG may be reduced, this contributes to an improvement in the usage efficiency of wireless resources.

Here, in order to assist understanding of the benefits of introducing an arrangement for switching between response formats, the differences between the TB method and the CBG method and the arrangement for retransmission control according to the second embodiment will now be described further by way of a specific example.

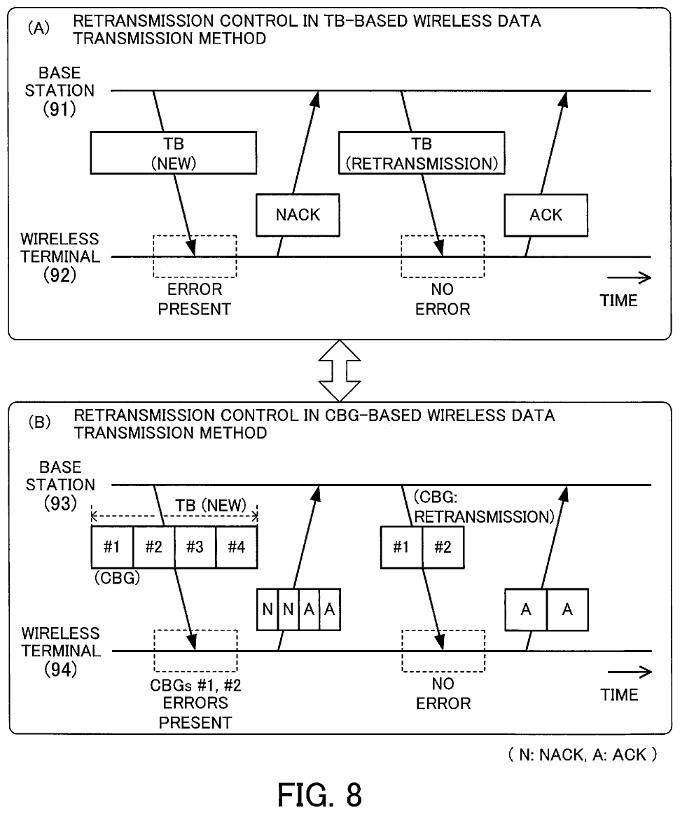

The difference between the TB-based wireless data transmission method (hereinafter the “TB method”) and the CBG-based wireless data transmission method (hereinafter the “CBG method”) will now be described with reference to FIG. 8. FIG. 8 is a diagram useful in explaining the difference between the TB-based wireless data transmission method (TB method) and the CBG-based wireless data transmission method (CBG method).

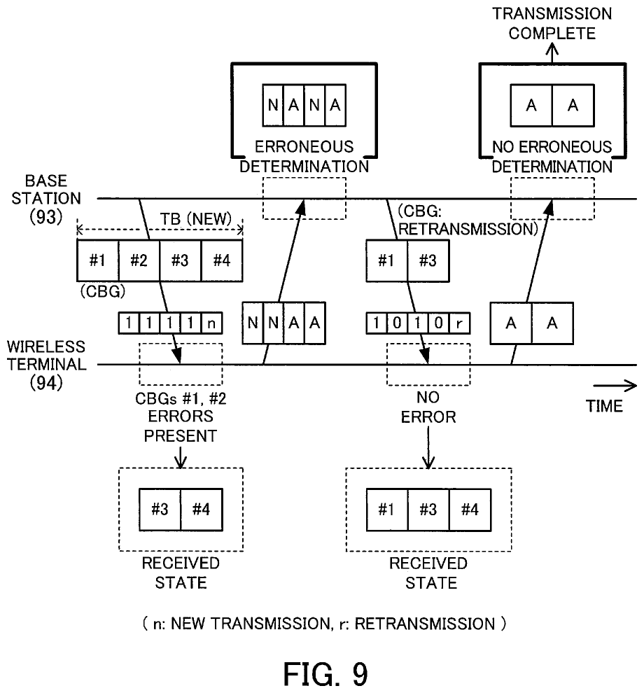

Note that in the description of FIG. 8 and FIG. 9, for ease of explanation, a base station and a wireless terminal that use the TB method are labeled as the “base station 91” and the “wireless terminal 92”, and a base station and a wireless device that use the CBG method are labeled as the “base station 93” and the “wireless terminal 94”.

With the TB method, as depicted in part (A) of FIG. 8, a new TB is transmitted from the base station 91, and error detection is performed on the entire TB during reception at the wireless terminal 92. In this example, an error is detected at the wireless terminal 92, so that the wireless terminal 92 sends back a NACK to the base station 91. The base station 91 retransmits the TB in response to reception of the NACK. When the retransmitted TB is properly received and no error is detected at the wireless terminal 92, the wireless terminal 92 sends back an ACK to the base station 91. The base station 91 completes the transmission of the TB in response to the ACK being received.

On the other hand, with the CBG method, as depicted in part (B) of FIG. 8, a new TB is transmitted from the base station 93, and error detection is performed in units of CBGs during reception at the wireless terminal 94. In this example, error detection is performed for the four CBGs #1, #2, #3, and #4 included in the TB, and errors are detected in CBGs #1 and #2. In this case, the wireless terminal 94 sends back a NACK for each of CBGs #1 and #2, and sends back an ACK for each of CBGs #3 and #4.

In part (B) of FIG. 8, “N” represents a NACK, “A” represents an ACK, and the four blocks in which an N or an A is written represent the ACK/NACK signals corresponding to CBGs #1, #2, #3, and #4 in order from the left. For ease of explanation, the same notation may be used later in this description.

The base station 93 receives a response signal including four ACK/NACK signals corresponding to CBGs #1, #2, #3, and #4, and specifies CBGs #1 and #2 that correspond to a NACK. The base station 93 then retransmits the specified CBGs #1 and #2 to the wireless terminal 94. When the retransmitted CBGs #1 and #2 are properly received and no error is detected at the wireless terminal 94, the wireless terminal 94 sends back two ACKs for CBGs #1 and #2 to the base station 93. The base station 93 completes the transmission of the TB in response to the two ACKs being received.

As described above, although an entire TB is retransmitted with the TB method, only CBGs for which an error has been detected are retransmitted with the CBG method. This means that the CBG method reduces the amount of data to be retransmitted compared to the TB method, which contributes to improvement in usage efficiency of wireless resources.

On the other hand, when the amount of power that may be used for an ACK/NACK response is limited to a predetermined maximum amount of power, there are cases where the amount of power that may be allocated to one ACK/NACK signal is less with the CBG method than with the TB method.

With the TB method, since one ACK/NACK signal is transmitted for one TB, the maximum amount of power may be used for the transmission of one ACK/NACK signal. On the other hand, with the CBG method, the amount of power that may be allocated to one ACK/NACK signal falls according to the number of CBGs to be newly transmitted or retransmitted. Conversely, when the amount of power allocated to one ACK/NACK signal is set at the same as with the TB method, the total amount of power will increase with the CBG method compared to the TB method to 10·Log (number of CBGs) [dB].

Normally, when the transmission power of a signal is low, an error is more likely to occur during reception of the signal. Erroneous determination of ACK/NACK signals also leads to a fall in the usage efficiency of in wireless resources described later.

The fall in usage efficiency of wireless resources that results from erroneous determination of ACK/NACK will now be described with reference to FIG. 9 for an example case where the CBG method is used. FIG. 9 is a diagram useful in explaining the fall in usage efficiency of wireless resources that results from erroneous determination of ACK/NACK.

In the example in FIG. 9, a TB including four CBGs #1, #2, #3, and #4 is transmitted from the base station 93, and the wireless terminal 94 performs error detection on each of the CBGs #1, #2, #3, and #4. In this example, errors are detected in CBGs #1 and #2, and CBGs #3 and #4 are regarded as received. In this case, the wireless terminal 94 sends back a NACK for each of CBGs #1 and #2 and an ACK for each of CBGs #3 and #4 to the base station 93.

When the base station 93 is able to correctly determine ACK/NACK for all of CBGs #1, #2, #3, and #4, appropriate retransmission control will be performed as depicted in part (B) of FIG. 8. However, in the example in FIG. 9, the base station 93 erroneously determines that the NACK for CBG #2 is an ACK, and erroneously determines that the ACK for CBG #3 is a NACK. At this time, the base station 93 is not aware that these determinations are erroneous. For this reason, the base station 93 retransmits CBGs #1 and #3 corresponding to the NACKs in the determination result.

The wireless terminal 94 receives the retransmitted CBGs #1 and #3 and performs error detection on the received CBGs #1 and #3. In the example in FIG. 9, no error is detected for CBGs #1 and #3, and the wireless terminal 94 sends back an ACK for each of CBGs #1 and #3. At this time, at the wireless terminal 94, CBGs #1, #3, and #4 are in a received state, but CBG#2 is in an unreceived state. In spite of this, the base station 93 receives the ACKs for CBGs #1 and #3 from the wireless terminal 94 and determines that transmission is complete.

In this case, since transmission of CBG #2 has not actually been completed, the transmission of the TB ends with a part of the TB missing. This may result, for example, in an error being detected on the upper layer and transmission of the same TB being repeated from the beginning. This repeated transmission of a TB causes a waste of wireless resources and destroys the benefit of using the CBG method. For this reason, in the second embodiment, an arrangement that reduces the risk of erroneous determination of ACK/NACK and thereby suppresses falls in the usage efficiency of wireless resources is introduced.

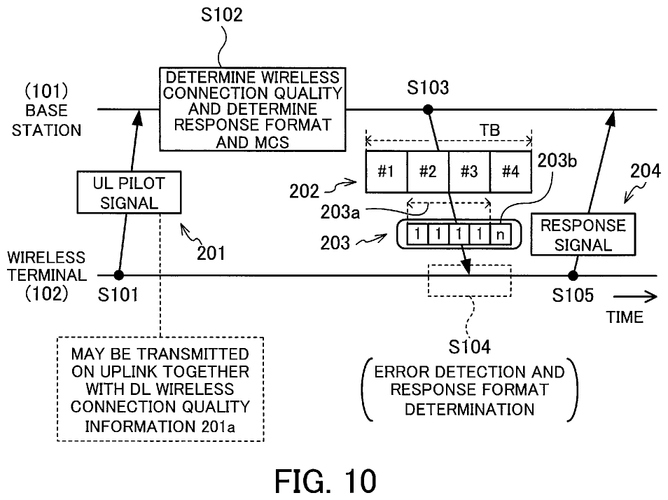

Next, the arrangement used for retransmission control according to the second embodiment will be described with reference to FIG. 10. FIG. 10 is a diagram useful in explaining the arrangement for retransmission control according to the second embodiment.

The following description will trace steps 5101 to S105 in FIG. 10.

(S101) The wireless terminal 102 transmits a UL pilot signal 201 to the base station 101. The UL pilot signal 201 is transmitted at predetermined timing using a physical data channel, such as PUSCH. The wireless terminal 102 may transmit DL wireless connection quality information 201a indicating the wireless connection quality of the downlink (DL) on an uplink. CQI is one example of the DL wireless connection quality information 201a.

(S102) The base station 101 determines the wireless connection quality and/or determines the response format and MCS based on the measurement result of the UL pilot signal 201 received from the wireless terminal 102.

As one example, the base station 101 determines the MCS index based on the determination result of the wireless connection quality, and specifies the range that includes the determined MCS index based on the format determination information (see FIG. 6). The base station 101 then determines a response format corresponding to the specified range. When the DL wireless connection quality information 201a has been transmitted on the uplink, the base station 101 also considers the DL wireless connection quality information 201a when determining the wireless connection quality and/or determining the response format and MCS.

(S103) The base station 101 modulates and encodes the data signal 202 with the modulation scheme and the coding rate corresponding to the determined MCS index, and transmits the data signal 202 to the wireless terminal 102. In addition, the base station 101 transmits an L1 control signal 203, which includes a BM 203a indicating which CBG are included in the data signal 202 and an NR 203b indicating whether the transmission is new data transmission or a retransmission.

In the example in FIG. 10, a data signal 202 including four CBGs #1, #2, #3, and #4 is transmitted. In this case, the BM 203a included in the L1 control signal 203 has four bit values “1” (bit values indicating inclusion of CBGs in the data signal 202) corresponding to CBGs #1, #2, #3, and #4. The NR 203b has a flag “n” indicating that the transmission is new data transmission.

(S104) The wireless terminal 102 recognizes CBGs #1, #2, #3, and #4 included in the data signal 202 from the BM 203a of the L1 control signal 203, and performs error detection on CBGs #1, #2, #3, and #4. The wireless terminal 102 also specifies a range including the MCS index indicating the MCS applied to the transmission of the data signal 202 from the format determination information (see FIG. 6), and determines the response format corresponding to the specified range.

(S105) The wireless terminal 102 generates a response signal 204 which has the response format determined in S104 and is based on the result of the error detection performed in S104, and transmits the generated response signal 204 to the base station 101.

As one example, when an error is detected for CBGs #1 and #2 but no error is detected for CBGs #3 and #4, in the case of format #1, a response signal 204 including one ACK/NACK signal indicating a NACK is transmitted to the base station 101. On the other hand, in the case of format #2, a response signal 204 including two ACK/NACK signals indicating a NACK for each of CBGs #1 and #2 and two ACK/NACK signals indicating an ACK for each of CBGs #3 and #4 is transmitted to the base station 101.

As described above, in the case of format #1, the amount of power allocated to one ACK/NACK signal is larger compared to the case of format #2 that transmits an equal number of ACK/NACK signals to the number of CBGs, which makes it less likely for erroneous determination of ACK/NACK to occur at the base station 101. On the other hand, with format #2, since the number of retransmission target CBGs may fall, this contributes to an improvement in the usage efficiency of wireless resources.

Operation

Next, the operation of the base station 101 and the wireless terminal 102 will be described.

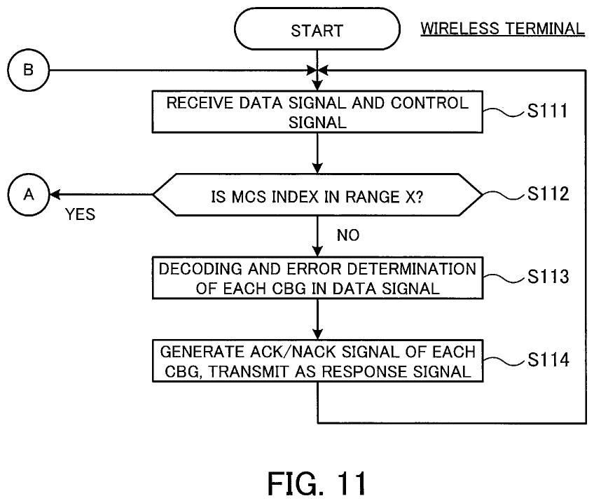

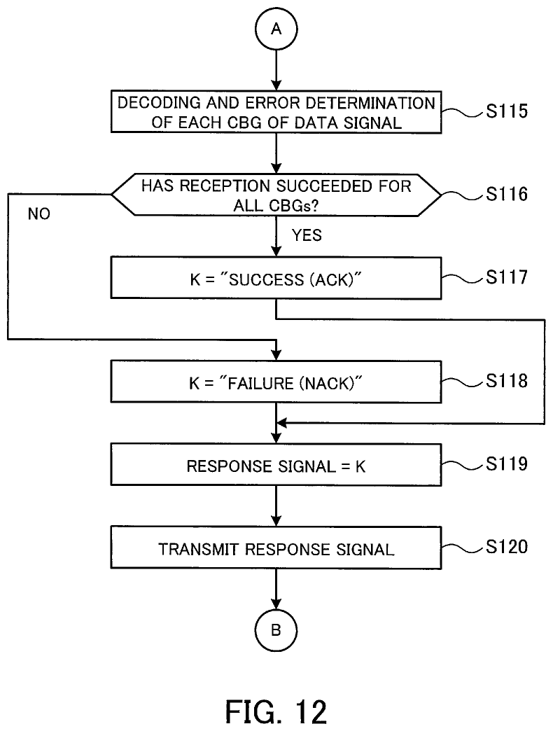

First, the operation of the wireless terminal 102 will be described with reference to FIGS. 11 and 12. FIG. 11 is a first flowchart depicting the operation of the wireless terminal according to the second embodiment. FIG. 12 is a second flowchart depicting the operation of the wireless terminal according to the second embodiment.

(S111) The wireless reception unit 133 receives a data signal via the reception antenna Rx. Note that when new data is being transmitted, the wireless reception unit 133 receives a data signal including an entire TB. On the other hand, in the case of a retransmission, a data signal including CBGs corresponding to NACKs out of the CBGs included in a TB are received by the wireless reception unit 133.

The wireless reception unit 133 also receives a control signal together with the data signal. This control signal includes, as one example, a Bitmap flag (BM) indicating which CBGs are included in the data signal out of the CBGs included in the TB, and a retransmission determination flag (NR) indicating whether the data transmission is new data transmission or a retransmission.

The data signal and the control signal received by the wireless reception unit 133 are demodulated by the demodulation unit 137, the data signal is outputted to the data signal decoding unit 139, and the control signal is outputted to the control signal decoding unit 138.

(S112) The operation mode determination unit 141 determines whether the MCS index indicating the MCS applied to the transmission of the data signal is within the range X (see FIG. 6). Note that notification of the MCS index may be given in advance via the PDCCH as part of the DCI, for example.

When the MCS index is within the range X (that is, when format #1 is applied), the processing proceeds to S115. On the other hand, when the MCS index is outside the range X (that is, in the range Y) (when format #2 is applied), the processing proceeds to S113.

(S113) The data signal decoding unit 139 recognizes whether the transmission is new data transmission or a retransmission based on the decoding result (BM, NR) for the control signal produced by the control signal decoding unit 138, and specifies the CBGs included in the data signal.

The data signal decoding unit 139 also performs decoding for each CBG in the data signal and outputs each decoded CBG to the error determination unit 140. The error determination unit 140 performs error detection on each CBG using the CRC assigned to each CBG, and determines whether there is an error for each CBG.

(S114) The ACK/NACK signal generation unit 142 generates an ACK/NACK signal for each CBG based on the determination results of the error determination unit 140, and transmits a response signal including the ACK/NACK signal for each CBG to the base station 101.

As one example, when an error is detected for CBGs #1 and #2, the ACK/NACK signal generation unit 142 generates an ACK/NACK signal indicating NACK for each of CBGs #1 and #2. When no error is detected for CBGs #3 and #4, the ACK/NACK signal generation unit 142 generates an ACK/NACK signal indicating ACK for each of CBGs #3 and #4. The ACK/NACK signal generation unit 142 then transmits a response signal including the four generated ACK/NACK signals.

When the processing in S114 is complete, the processing returns to S111.

(S115) The data signal decoding unit 139 recognizes whether the data transmission is new data transmission or a retransmission based on the decoding result (BM, NR) of the control signal produced by the control signal decoding unit 138, and specifies the CBG included in the data signal.

In addition, the data signal decoding unit 139 performs decoding for each CBG in the data signal and outputs each decoded CBG to the error determination unit 140. The error determination unit 140 performs error detection on each CBG using the CRC assigned to each CBG and determines whether there is an error for each CBG.

(S116) Based on the results of error detection by the error determination unit 140, the operation mode determination unit 141 determines whether all of the CBGs included in the data signal have been successfully received (that is, there are no errors for any of the CBGs). When all the CBGs have been successfully received, the processing proceeds to S117. On the other hand, when reception has failed for at least one CBG, the processing proceeds to S118.

(S117) The operation mode determination unit 141 sets a parameter K at “success” (ACK). When the processing in S117 is complete, the processing proceeds to S119.

(S118) The operation mode determination unit 141 sets the parameter K at “failure” (NACK). When the processing in S118 is complete, the processing proceeds to S119.

(S119) The ACK/NACK signal generation unit 142 generates a response signal with the content of the parameter K set by the operation mode determination unit 141.

The response signal generated in S119 is composed of one ACK/NACK signal indicating whether all of the transmitted CBGs were successfully received (ACK) or at least one CBG failed to be received (NACK). With a response signal of this format (format #1), since the maximum allowed amount of power may be allocated to one ACK/NACK signal, it is possible to suppress the risk of erroneous determination of ACK/NACK due to insufficient power.

(S120) The wireless transmission unit 132 transmits the response signal generated by the ACK/NACK signal generation unit 142 to the base station 101. When the processing in S120 is complete, the processing returns to S111.

Note that the series of processing depicted in FIGS. 11 and 12 ends in response to the wireless terminal 102 being powered down, the user performing a termination operation, or the like.

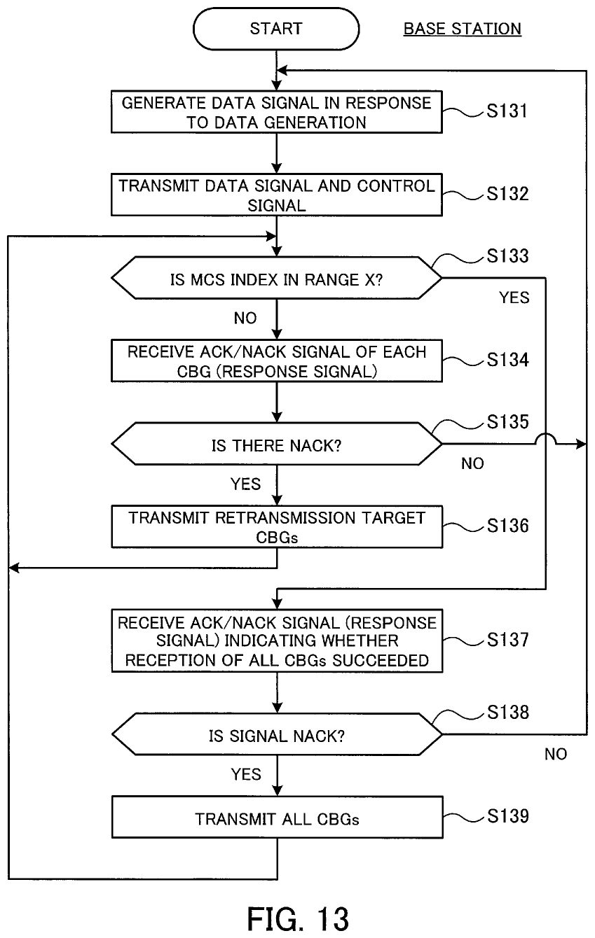

Next, the operation of the base station 101 will be described with reference to FIG. 13. FIG. 13 is a flowchart depicting the operation of the base station according to the second embodiment.

(S131) In response to the generation of new data to be transmitted to the wireless terminal 102, the data signal generation unit 111 generates a data signal (TB).

(S132) The control signal generation unit 112 creates a BM corresponding to the data signal generated by the data signal generation unit 111 and an NR indicating that the transmission is transmission of new data. The control signal generation unit 112 then generates a control signal including the generated BM and NR. The multiplexing unit 113 and the wireless transmission unit 114 multiplex and transmit the control signal generated by the control signal generation unit 112 and the data signal generated by the data signal generation unit 111.

(S133) The operation mode determination unit 121 determines whether the MCS index indicating the MCS applied to the transmission of the data signal is within the range X (see FIG. 6). Note that the MCS index is determined in advance by the MCS determination unit 122, and the notification of the MCS index is given to the wireless terminal 102 via the PDCCH as part of the DCI, for example.

When the MCS index is within the range X (that is, when format #1 is to be used), the processing proceeds to S137. On the other hand, when the MCS index is outside the range X (that is, in the range Y) (when format #2 is to be used), the processing proceeds to S134.

(S134) The wireless reception unit 115 receives the response signal via the reception antenna Rx.

The response signal received by the wireless reception unit 115 in S134 includes an ACK/NACK signal indicating reception success or failure for each CBG included in the data signal transmitted in S132. That is, a response signal including the same number of ACK/NACK signals as the number of CBGs is received. The response signal received by the wireless reception unit 115 is demodulated by the demodulation unit 116 and outputted to the ACK/NACK signal reception unit 118.

(S135) The ACK/NACK signal reception unit 118 performs ACK/NACK determination for each CBG from the content of the ACK/NACK signals included in the received response signal. The ACK/NACK signal reception unit 118 then determines whether there is a NACK in the response signal (that is, whether there is a CBG corresponding to a NACK). When there is a NACK, the processing proceeds to S136. On the other hand, when there is no NACK, the processing returns to S131. Note that when there are no NACK at all, the base station 101 completes the transmission of the data generated in S131.

(S136) The data signal generation unit 111 sets CBGs corresponding to each NACK as retransmission target CBGs and generates a data signal including the retransmission target CBGs. The control signal generation unit 112 generates a control signal including a BM indicating that the retransmission target CBGs are included in the data signal and an NR indicating that this transmission is a retransmission. The multiplexing unit 113 and the wireless transmission unit 114 multiplex and transmit the control signal generated by the control signal generation unit 112 and the data signal generated by the data signal generation unit 111. When the processing in S136 is complete, the processing returns to S133.

(S137) The wireless reception unit 115 receives the response signal via the reception antenna Rx.

The response signal received by the wireless reception unit 115 in S137 includes an ACK/NACK signal indicating whether every CBG included in the data signal transmitted in S132 has been successfully received. That is, a response signal including a single ACK/NACK signal is received. The response signal received by the wireless reception unit 115 is demodulated by the demodulation unit 116 and outputted to the ACK/NACK signal reception unit 118.

(S138) The ACK/NACK signal reception unit 118 performs ACK/NACK determination from the content of the ACK/NACK signal included in the received response signal, and determines whether the signal indicates NACK. When NACK is indicated, the processing proceeds to S139. On the other hand, when ACK is indicated, the processing returns to S131. In the case of ACK, the base station 101 completes the transmission of the data generated in S131.

(S139) The data signal generation unit 111 sets all CBGs transmitted in the previous transmission as retransmission target CBGs, and generates a data signal including the retransmission target CBGs. The control signal generation unit 112 generates a control signal including a BM indicating that the retransmission target CBGs are included in the data signal and an NR indicating that the transmission is a retransmission. The multiplexing unit 113 and the wireless transmission unit 114 multiplex and transmit the control signal generated by the control signal generation unit 112 and the data signal generated by the data signal generation unit 111. When the processing of S139 is complete, the processing returns to S133.

Note that the series of processing depicted in FIG. 13 ends in response to the base station 101 being powered down, the user performing a termination operation, or the like.

Modification

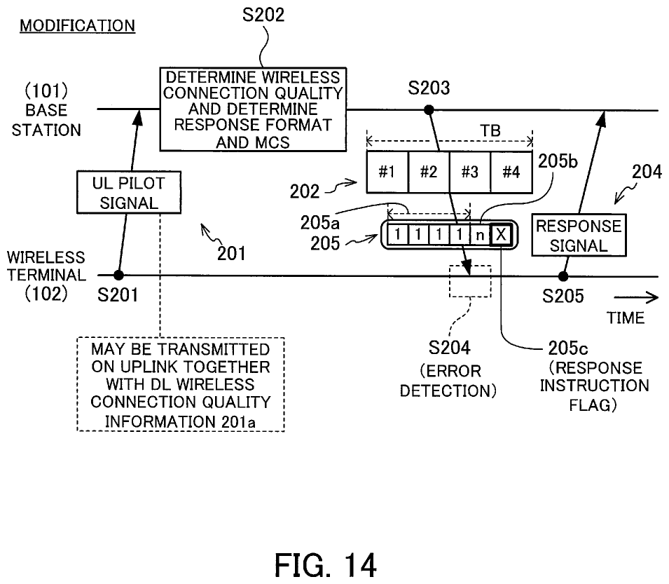

A modification to the second embodiment will now be described with reference to FIG. 14. FIG. 14 is a diagram useful in explaining a modification to the second embodiment.

In this modification, instead of determining the response format from the MCS at the wireless terminal 102, an arrangement is introduced where a response instruction flag indicating the response format decided by the base station 101 is transmitted to the wireless terminal 102 and the wireless terminal 102 transmits a response signal in the response format indicated by the response instruction flag. This arrangement will now be described in more detail.

(S201) The wireless terminal 102 transmits a UL pilot signal 201 to the base station 101. Note that the UL pilot signal 201 is transmitted at predetermined timing using a physical data channel, such as PUSCH. The wireless terminal 102 may transmit DL wireless connection quality information 201a indicating the DL wireless connection quality on an uplink. Here, CQI is one example of the DL wireless connection quality information 201a.

(S202) The base station 101 determines the wireless connection quality and/or determines the response format and MCS based on a measurement result of the UL pilot signal 201 received from the wireless terminal 102.

As one example, the base station 101 determines the MCS index based on the determination result of the wireless connection quality, and specifies the range that includes the determined MCS index based on the format determination information (see FIG. 6). The base station 101 then determines a response format corresponding to the specified range. Note that when the DL wireless connection quality information 201a has been transmitted on the uplink, the base station 101 also considers the DL wireless connection quality information 201a when determining the wireless connection quality and/or determining the response format and MCS.

(S203) The base station 101 modulates and encodes the data signal 202 with the modulation scheme and the coding rate corresponding to the determined MCS index and transmits the data signal to the wireless terminal 102. The base station 101 also transmits an L1 control signal 205, which includes a BM 205a indicating which CBGs are included in the data signal 202, an NR 205b indicating whether the transmission is new data transmission or a retransmission, and a response instruction flag 205c indicating the response format.

In the example in FIG. 14, a data signal 202 including four CBGs #1, #2, #3, and #4 is transmitted. In this case, the BM 205a included in the L1 control signal 205 has four bit values “1” (bit values indicating inclusion of CBGs in the data signal 202) corresponding to CBGs #1, #2, #3, and #4. The NR 205b has a flag “n” indicating transmission of new data. The response instruction flag 205c has a flag “X” indicating format #1 (that is, the response format corresponding to the range X).

(S204) The wireless terminal 102 recognizes that CBGs #1, #2, #3, and #4 are included in the data signal 202 from the BM 205a of the L1 control signal 205, and performs error detection on CBGs #1, #2, #3, and #4. The wireless terminal 102 also determines the response format based on the response instruction flag 205c.

(S205) The wireless terminal 102 generates, based on the result of error detection performed in S204, a response signal 204 with the response format determined in S204 and transmits the generated response signal 204 to the base station 101.

As one example, when an error has been detected for CBGs #1 and #2 and no error has been detected for CBGs #3 and #4, in the case of format #1, a response signal 204 including one ACK/NACK signal indicating a NACK is transmitted to the base station 101. On the other hand, in the case of format #2, a response signal 204 including two ACK/NACK signals indicating a NACK for each of CBGs #1 and #2 and two ACK/NACK signals indicating an ACK for each of CBGs #3 and #4 is transmitted to the base station 101.

Also in this modification, the amount of power allocated to one ACK/NACK signal is larger when format #1 is used than when format #2 where an equal number of ACK/NACK signals to the number of CBGs are transmitted is used. This makes erroneous determination of ACK/NACK less likely to occur at the base station 101. On the other hand, when format #2 is used, since the number of retransmission target CBGs may fall, this contributes to an improvement in the usage efficiency of wireless resources. By also using the response instruction flag 205c, it is possible to omit determination of the response format at the wireless terminal 102, which reduces the load of the wireless terminal 102.

In the above description, although a method of applying the arrangement in the second embodiment to communication between a base station and a wireless terminal has been described for ease of explanation, it is also possible to apply the arrangement to communication between a relay station or another wireless device and the base station or the wireless terminal. As one example, when this arrangement is applied to communication between a base station and a relay station, the functions of the wireless terminal described above are introduced into the relay station. Likewise, when this arrangement is applied to communication between a relay station and a wireless terminal, the functions of the base station described above are introduced into the relay station. That is, the arrangement of the second embodiment may be applied even when the component elements of the wireless communication system 100 are changed. It is obvious that these modifications also belong to the technical scope of the second embodiment.

This completes the description of the second embodiment.

According to the embodiments described above, it is possible to reduce the risk of erroneous determination of ACK/NACK.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A wireless communication method used in a wireless communication system including a first wireless apparatus and a second wireless apparatus, the wireless communication method comprising:
receiving, by the first wireless apparatus, a first signal composed of a plurality of parts and a second signal including first information about the first signal from the second wireless apparatus; and
transmitting, by the first wireless apparatus, second information indicating a reception result of the first signal to the second wireless apparatus using a mode determined based on the first information included in the second signal, out of a plurality of modes in which the reception result is expressed differently.

2. The wireless communication method according to claim 1,
wherein the first information is information on processing to be applied to the first signal by the second wireless apparatus.

3. The wireless communication method according to claim 1,
wherein the first information is a numeric value decided by a combination of a modulation scheme and a coding rate that are applied to the first signal.

4. The wireless communication method according to claim 3,
wherein when the numeric value is larger than a value designated in advance, the mode to be used for the transmitting of the second information is determined at a first mode where a separate reception result is expressed for each of the plurality of parts that compose the first signal, and
when the numeric value is smaller than the value designated in advance, the mode to be used for the transmitting of the second information is determined at a second mode where a reception result is expressed for the entire first signal.

5. A wireless terminal that communicates with a base station, the wireless terminal comprising:
a reception unit that receives a first signal composed of a plurality of parts and a second signal including first information about the first signal from the base station; and
a transmission unit that transmits second information indicating a reception result of the first signal to the base station using a mode determined based on the first information included in the second signal, out of a plurality of modes in which the reception result is expressed differently.

6. A base station that communicates with a wireless terminal, the base station comprising:
a transmission unit that transmits a first signal composed of a plurality of parts and a second signal including first information about the first signal to the wireless terminal; and
a reception unit that receives second information, which indicates a reception result of the first signal from the wireless terminal and is transmitted using a mode determined based on the first information included in the second signal, out of a plurality of modes in which the reception result is expressed differently.
